(19) United States
(12) Patent Application Publication
(10) Pub. No.: US 2025/0182554 A1
(43) Pub. Date: Jun. 5, 2025

(54) SYSTEMS AND METHODS FOR SECURE BALLOT DROP-OFF

(71) Applicant: Runbeck Election Services, Inc., Phoenix, AZ (US)

(72) Inventors: Jeff Ellington, Phoenix, AZ (US); Joe Bean, Phoenix, AZ (US); James Suver, Phoenix, AZ (US)

(21) Appl. No.: 18/965,807

(22) Filed: Dec. 2, 2024

Related U.S. Application Data
(60) Provisional application No. 63/605,257, filed on Dec. 1, 2023.

(51) Int. Cl. G07C 13/02

(52) U.S. Cl. CPC G07C 13/02

(57) ABSTRACT

A ballot envelope receipt system includes a ballot box having an integrated computing system that communicates directly with an external entity computing system for improved receipt of ballot envelopes that are returned during a voting process. The ballot box is outfitted with tamper and theft preventive components and is further configured to prevent voter fraud events such as mass ballot drops.

### CROSS REFERENCE TO RELATED APPLICATIONS

This is a non-provisional application that claims benefit to U.S. Provisional Application Ser. No. 63/605,257, filed on Dec. 1, 2023, which is herein incorporated by reference in its entirety.

### FIELD

The present disclosure generally relates to voting systems, and in particular, to a system and associated method for a ballot drop box for secure ballot drop-off.

### BACKGROUND

Some citizens who participate in voting processes are suspicious of unsupervised ballot drop-off boxes, which are often placed outside of public spaces such as stores and municipal buildings. Poll workers and officials often have many responsibilities and limited time; to supervise every ballot drop off box can be an unrealistic expectation. Ballot drop off boxes are often subject to tampering. As such, there is room for improvement in this field.

It is with these observations in mind, among others, that various aspects of the present disclosure were conceived and developed.

### BRIEF DESCRIPTION OF THE DRAWINGS

FIG. 1 is a simplified illustration showing a ballot envelope receipt system including a ballot box;

FIG. 2 is a simplified illustration showing a front of the ballot box of FIG. 1;

FIG. 3 is a simplified illustration showing a side cutaway view of the ballot box of FIG. 2;

FIG. 4 is a simplified diagram showing data flow between various electronic components of the ballot envelope receipt system of FIG. 1;

FIGS. 5A and 5B are a series of process flows showing a method for receiving ballot envelopes using the ballot envelope receipt system of FIGS. 1; and

FIG. 6 is a simplified diagram showing an exemplary computing system for implementation of one or more electronic components of the ballot envelope receipt system of FIG. 1.

Corresponding reference characters indicate corresponding elements among the view of the drawings. The headings used in the figures do not limit the scope of the claims.

### DETAILED DESCRIPTION

Examples of a system and associated methods for secure receipt of a ballot envelope are disclosed herein. In some examples, a ballot envelope receipt system as disclosed herein includes a ballot box having an integrated computing system that can communicate directly with a remote and/or external computing system for improved receipt of ballot envelopes that are returned during a voting process. The ballot box can be outfitted with tamper and theft preventive components, and can be further configured to prevent voter fraud events such as mass ballot drops. In some embodiments, the ballot box is operable to scan both sides of a received ballot envelope to extract ballot information, record a timestamp indicative of a time that the ballot envelope was received, and relay the timestamp with the ballot information to the external computing system. Further, in some embodiments, the ballot box is operable to obtain voter information by scanning a voter identification card or another suitable identification card for further authentication of a voter returning a ballot. The external computing system can send a notification to the voter based on the extracted ballot information with a confirmation message, which can include the timestamp and a box identifier indicative of the ballot box that received the associated ballot envelope.

When deployed as a platform, the ballot envelope receipt system can include a plurality of ballot boxes that each respectively include a unique box identifier. In one embodiment, the ballot box can include a plurality of cameras including a first camera configured to capture one or more images or video data of a surrounding environment and a second camera configured to capture one or more images or video data of a person interacting with the ballot box. The ballot box can further implement one or more voter fraud prevention measures, including a timestamp check that flags when two or more ballot envelopes are placed within the ballot box within a minimum time interval. As such, the ballot envelope receipt system provides improved security and confidence in election integrity by ensuring that ballot envelopes received at the ballot box are valid and further supports communication between a jurisdiction and a voter upon successful receipt of a ballot envelope.

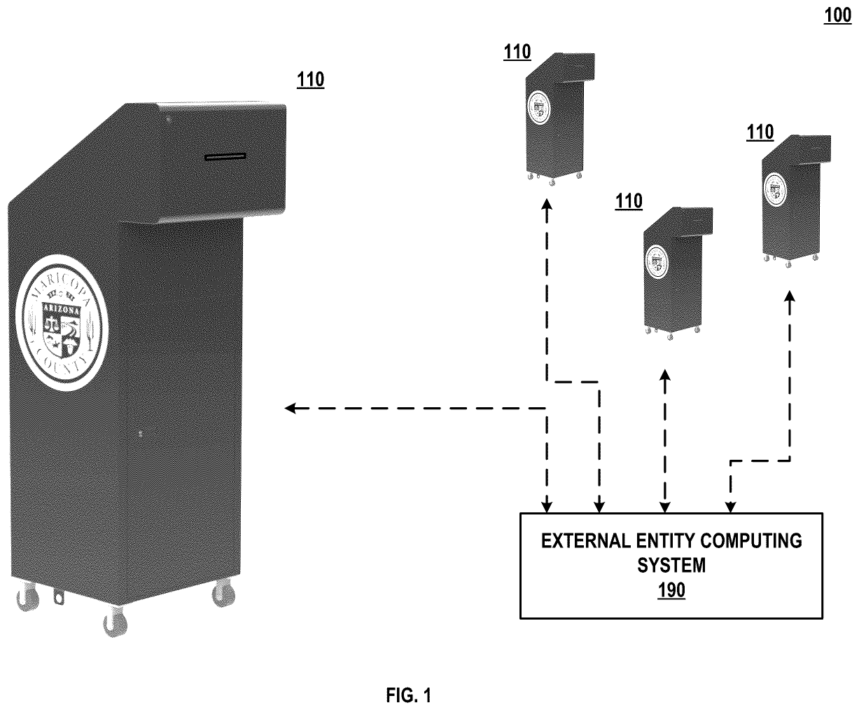

Referring first to FIG. 1, a ballot envelope receipt system 100 includes a ballot box 110 in communication with an external entity computing system 190 that includes or otherwise communicates with a voting information database for an entity holding a voting process. The ballot box 110 is configured to receive a plurality of ballot envelopes that voters return to the entity over the course of an election day. The ballot box 110 further includes a computing system 160 that manages various functionalities of the ballot box 110 including image capture, timestamp recordation, and communication with the external entity computing system 190. In the embodiment shown, the ballot envelope receipt system 100 can include a plurality of ballot boxes 110 that can be placed at different locations within a jurisdiction that communicate with the external entity computing system 190.

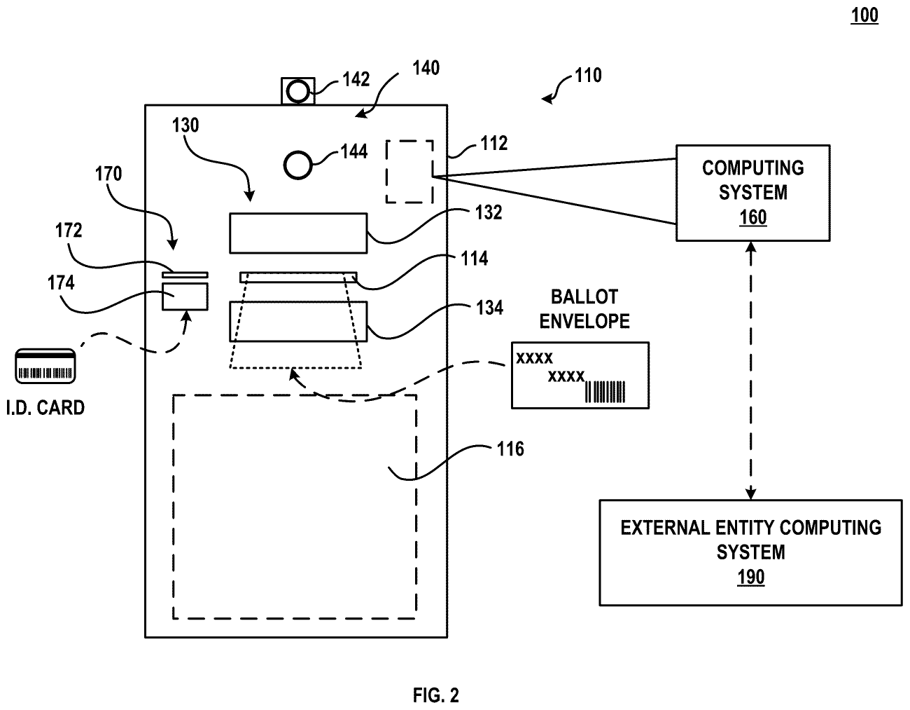

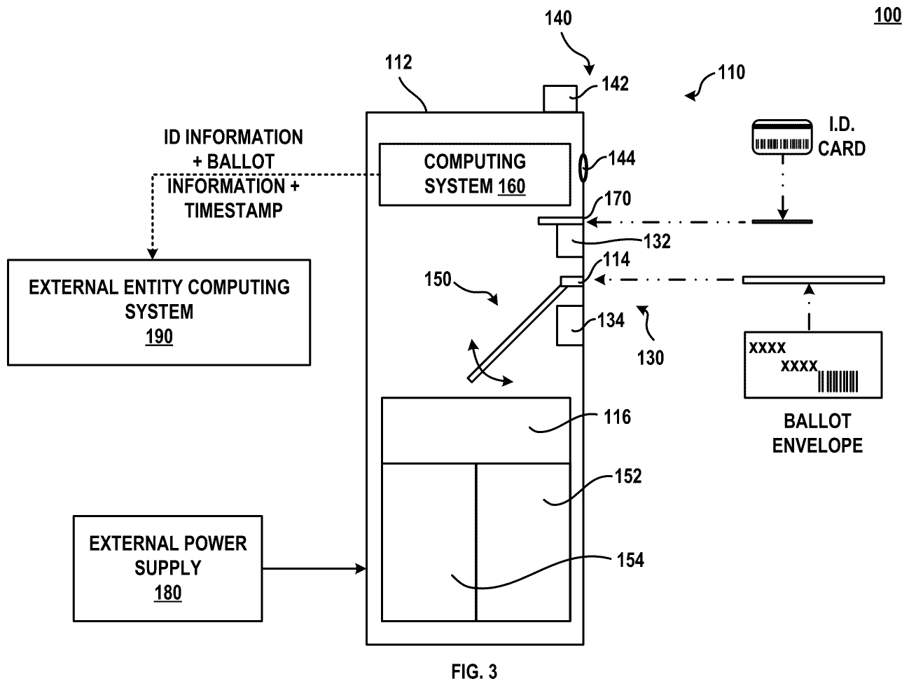

With reference to FIGS. 2 and 3, the ballot box 110 includes a body 112 that includes an entrance portal 114 configured to receive a ballot envelope. The entrance portal 114 communicates with an internal container 116, which can include a plurality of sub-containers. The entrance portal 114 is equipped with a lock that prevents access to the internal container 116 when engaged. In some embodiments, the lock can be manually-actuated and/or can be linked to a clock of the computing system 160 such that the entrance portal 114 is only operable to receive ballot envelopes within a predetermined time interval, which can be defined as the start of the voting day and the end of the voting day (e.g., the lock disengages when polls open and re-engages when polls close). The ballot box 110 can further include a door that enables poll workers to open the internal container 116 and collect the ballot envelopes that are received within the internal container 116. Alternatively, the ballot box 110 can be configured without such physical exclusion measures, and can instead track ballot receipt and verify the same using time stamp measures as described herein.

In some embodiments, the ballot box 110 can include various anti-theft and tampering measures such as concrete anchors. For temporary placement of the ballot box, concrete might not be practical, and the ballot box 110 can include one or more apertures paired with one or more chains threaded though the apertures which are fixed to a secure external object (such as a wall or dedicated coupling point cemented or otherwise securely coupled to the ground or an immovable object) that prevent the ballot box 110 from being stolen or moved without authorization. In some embodiments, the door and/or the entrance portal 114 can be equipped with one or more alarms that generate an alert if tampered with and communicate with the external entity computing system 190 or another external entity (e.g., security, police, the entity holding the election, etc.).

The entrance portal 114 can be configured to accept ballot envelopes with specific size parameters and can further be configured to only accept one ballot envelope at a time. In one example, this can be achieved by manufacturing the entrance portal 114 to only be large enough to accept one ballot envelope including a returned ballot at a time. The entrance portal 114 can include a scanner system 130 for scanning ballot envelopes as they are received at the entrance portal 114. The scanner system 130 can include a first scanner 132 and a second scanner 134 positioned opposite from the first scanner 132 that respectively scan a first side and a second side of a ballot envelope as the ballot envelope is placed within the entrance portal 114. The scanner system 130 records a timestamp upon receipt of the ballot envelope and further extracts ballot information from ballot envelope indicia present on the ballot envelope, which can include a barcode or information derived from the barcode present on the ballot envelope. As such, the scanner system 130 can include an image capture device such as a camera and/or a laser-based reader device to capture a machine readable code or object, such as a QR code, a barcode and/or other indica. In some examples, the barcode includes a two-dimensional matrix barcode.

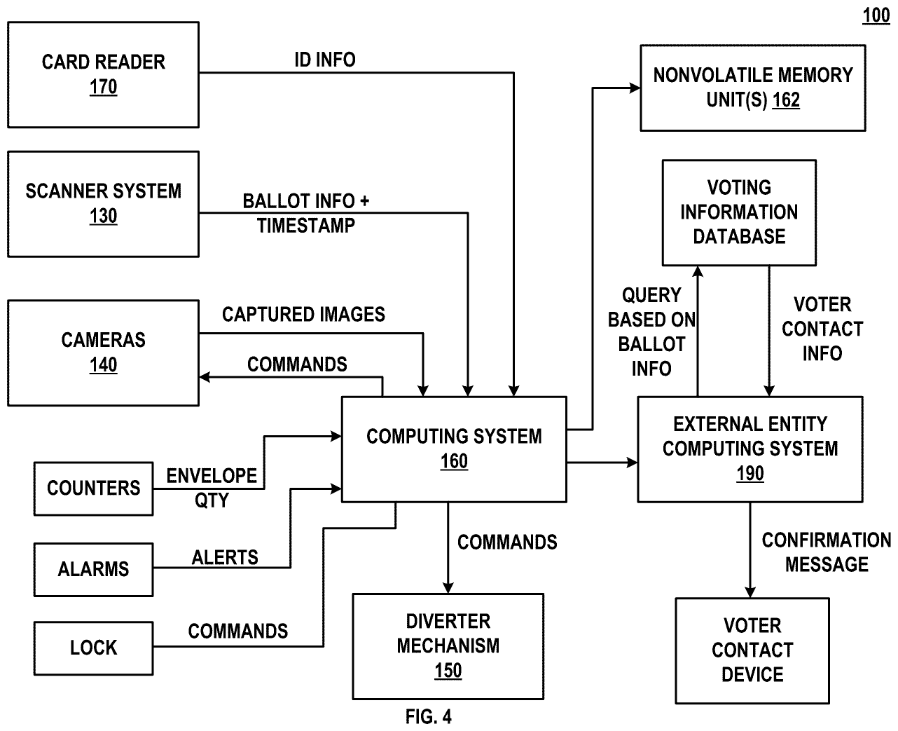

With additional reference to FIG. 4, the computing system 160 can save the extracted ballot envelope information, and timestamp, and can further communicate the extracted ballot envelope information and timestamp to the external entity computing system 190 for recording and for sending a confirmation message to the voter. For example, the computing system 160 of the ballot box 110 can extract ballot information including a ballot identifier from the ballot envelope information and send the extracted ballot identifier with a corresponding timestamp to the external entity computing system 190. The external entity computing system 190 can also obtain voter contact information from a voting information database based on the extracted ballot identifier and can send a confirmation message to the voter using the voter contact information that includes the timestamp and a ballot box identifier indicative of which ballot box 110 received the ballot envelope.

In some embodiments, the ballot box 110 can include a card reader system 170 in communication with the computing system 160 that is operable to scan a voter identification card and extract voter identification information from voter identification indicia present on the voter identification card. The voter identification card can be a government-issued identification card including a driver's license, a voter identification card, or another government-issued identification card, and the voter identification information can be related to voter information within the voting information database accessible by the external entity computing system 190. In other examples, the voter information can be extracted digitally via a mobile device, general computing device, or other otherwise the voter information may comprise digital information otherwise extractable (as opposed to being extracted from a card).

In one embodiment, the voter identification indicia can be in the form of a magnetic stripe readable by a magnetic stripe reader 172 of the card reader system 170 positioned along the ballot box 110. Further, the voter identification indicia can be in the form of a barcode readable by a barcode reader 174 of the card reader system 170 positioned along the ballot box 110. In some embodiments, the card reader system 170 can also be configured to read other types of computer-readable indicia such as radio frequency identification (RFID) tags or other wireless identification component that may be present or otherwise readable along the voter identification card (e.g., the voter information can be extracted using any wireless platform such as WiFi, Bluetooth, NFC, any radio frequency platform, and the like). In some embodiments, the card reader system 170 can employ the magnetic stripe reader 172 in addition to the barcode reader 174 for increased security and to offer more flexibility if a valid voter identification card has only one of a magnetic stripe or a barcode. The computing system 160 can communicate the voter identification information obtained using the card reader system 170 to the external entity computing system 190 along with the ballot information to identify the voter within the voting information database. In some embodiments, the computing system 160 can engage the lock of the entrance portal 114 of the ballot box 110 until the card reader system 170 successfully captures the voter information within the memory of the computing system 160. Following successful capture of voter information, the computing system 160 can disengage the lock of the entrance portal 114 or otherwise open the entrance portal 114 of the ballot box 110 to receive the ballot envelope. In some embodiments, failure to capture voter information can trigger a “try again” response. Further, upon failure to capture voter information, the ballot box 110 can optionally allow a voter to place their ballot envelope within the entrance portal, but can flag the ballot envelope and/or divert the ballot envelope into an “unscanned” sub-container in an operation which will be described in greater detail below. Alternatively (e.g., in other examples or embodiments), the ballot box 110 can simply admit or receive a ballot envelope without physical restriction, and a timestamp can be generated that corresponds to the receipt of the ballot envelope.

The computing system 160 can communicate the voter identification information obtained using the card reader system 170 to the external entity computing system 190 along with the ballot information for further verification of an identity of the voter and/or for verification that the received ballot envelope belongs to the voter that is interacting with the ballot box 110. In embodiments where the ballot information includes a type of ballot or ballot envelope that the voter is eligible for, then the computing system 160 and/or the external entity computing system 190 can use the voter information extracted using the voter identification card and the ballot information extracted from the ballot envelope to verify that the received ballot envelope is the correct ballot envelope for the voter. In another aspect, the computing system 160 may require a poll worker to scan an identification card at the card reader system 170 that identifies the poll worker as an authorized employee or volunteer before allowing the poll worker to access the internal container 116 and/or the computing system 160.

The ballot box 110 can further include one or more cameras 140 that capture an image of a person as they place the ballot envelope within the entrance portal 114 and can is also operable to capture one or more images of a surrounding environment. In some embodiments, the one or more cameras 140 can include a first camera 142 which captures one or more images of a surrounding environment and a second camera 144 that is oriented in such a way as to capture an image of a person placing the ballot envelope within the entrance portal 114, including a face and/or other distinguishing features such as clothing and stature. In some embodiments, the computing system 160 can save the captured images to a memory and/or can forward the captured images to the external entity computing system 190. In some embodiments, the one or more cameras 140 can receive commands to begin capturing images and/or video upon receipt of a ballot envelope at the scanner system 130, upon motion detection near the ballot box 110, and/or when the entrance portal 114 is opened.

In some embodiments, the ballot box 110 can include a diverter mechanism 150 that diverts a ballot envelope if the scanner system 130 fails to extract the ballot envelope information, if the card reader system 170 fails to extract voter identification information, and/or if the ballot envelope is received too close to one or more previously recorded timestamps. As such, the container 116 can include a first sub-container 152 for receiving successfully-scanned ballot envelopes and a second sub-container 154 for receiving unscanned ballot envelopes. The diverter mechanism 150 can be in the form of a “ramp” or “chute” that passively or actively diverts successfully-scanned or unscanned ballot envelopes. In one example implementation, successfully-scanned ballot envelopes can enter the first sub-container 152 by default without engaging the diverter mechanism 150, and the diverter mechanism 150 can be configured to engage when the scanner system 130 fails to scan the ballot envelope, diverting the unscanned ballot envelope into the second sub-container 154. Alternatively, unscanned ballot envelopes can enter the second sub-container 154 by default without engaging the diverter mechanism 150, which can instead be configured to engage when the scanner system 130 successfully scans the ballot envelope and diverts the successfully-scanned ballot envelope into the first sub-container 152. This can be advantageous in the event of a larger system failure such as a power outage, as unscanned envelopes will by default fall into the second sub-container 154 even if the diverter mechanism 150 is failing to engage, ensuring that all unscanned envelopes continue to fall into the correct sub-container.

In another aspect, the ballot box 110 can record information related to the event of unscanned ballot envelopes entering the second sub-container 154, including a timestamp. In some embodiments, the ballot box 110 can optionally include an additional camera (not shown) that records an image of the second sub-container 154 each time an unscanned ballot envelope entering the second sub-container 154 to capture information visible on the unscanned ballot envelope that can correlate with the timestamp, which can aid poll workers in correlating timestamps to unscanned ballot envelopes. The ballot box 110 can also record a total amount of unscanned ballot envelopes received. In some embodiments, a counter module that maintains the total count can be electronic in nature and can include a backup power source. In another embodiment, the counter module can be analog, and can incrementally increase a mechanical counter each time a ballot envelope enters the container 116, which can also include separable counters for each respective sub-container such as the first sub-container 152 or the second sub-container 154. In some embodiments, the first and second sub-containers 152 and 154 can be in the form of rectangular plastic or metal containers or canvas and/or polymer sacks configured to receive ballot envelopes and in compliance with the entity holding the election. In a preferred embodiment, the first and second sub-containers 152 and 154 are waterproof. Note that the container 116 can include a plurality of sub-containers greater than two.

Referring to FIG. 4, electronic components of the ballot box 110 such as the computing system 160, scanner system 130, lock, diverter mechanism 150 and alarms can be powered by an external power supply 180. In some embodiments, the external power supply 180 can include a grounded cable connectable to a power source or generator. The external power supply 180 can include a 110V source or another suitable rating. In another embodiment, the external power supply 180 can include a portable power supply such as a battery or solar panels. In another embodiment, the ballot box 110 can include one or more additional “backup” batteries or power sources that power the lock, the alarms, the counters and/or an emergency call system in case of a power outage or tampering. Further, the computing system 160 can include one or more nonvolatile memory units 162 such as flash memory and/or disk-based memory that would retain information recorded by the ballot box 110 including but not limited to voter identification information, ballot information, captured images, values of counters (e.g, ballot count in either “bin”), and/or operating data. In some embodiments, the computing system 160 can include two or more nonvolatile memory units 162 that can be positioned at differing locations along the ballot box 110 for redundancy in case of failure of one or more of the nonvolatile memory units 162.

The computing system 160 manages various functionalities of the ballot box 110 including scanning, information recordation and extraction, and communicates with the external entity computing system 190. In some embodiments, the computing system 160 is operable to perform various diagnostic measures on itself to ensure that the ballot box 110 is functioning properly and can communicate to the external entity computing system 190 if the computing system 160 detects a problem. Further, the computing system 160 is operable to transmit information about the ballot box 110 to the external entity computing system 190 that can include information about the scanned ballot envelopes including a total count of received envelopes, which can include sub-quantities such as a total count of successfully-scanned ballot envelopes and a total count of unscanned ballot envelopes. The information transmitted to the external entity computing system 190 can also include the voter identification information captured from a voter identification card, ballot information captured for each respective successfully-scanned ballot envelope and the timestamps that correspond with a time of capture of the ballot information, which correlate with a time that the ballot envelope was dropped off. In some embodiments, the computing system 160 can transmit one or more images captured by the one or more cameras 140 to the external entity computing system 190 continuously or when triggered by an event. For example, in some embodiments the computing system 160 can transmit one or more images to the external entity computing system 190 when the entrance portal 114 is opened, if the computing system 160 detects two or more timestamps within a certain interval (e.g., they are suspiciously close to one another, which can be indicative of ballot harvesting), and/or if the computing system 160 detects an event such as tampering. This information can be transmitted continuously, periodically, and/or at the end of a polling interval. Further, the computing system 160 can store this information in the one or more nonvolatile memory units 162.

For a ballot envelope received at the ballot box 110, the computing system 160 is operable to transmit ballot information about the ballot envelope including a timestamp and data indicative of a ballot identifier to the external entity computing system 190. Further, for a ballot received at the ballot box 110, the computing system 160 is operable to transmit voter identification information extracted from a voter identification card to the external entity computing system 190. The external entity computing system 190 can consult the voting information database including a registry of voters to retrieve voter information that is associated with the ballot identifier and/or the voter identification information, the ballot identifier already being known to the voting information database. The external entity computing system 190 can upload or otherwise record the information about the ballot envelope including the timestamp within the voting information database corresponding with the voter information based on the ballot identifier. In some embodiments, the computing system 160 can receive an image captured of the voter as they place the ballot envelope into the entrance portal 114 and forward the image to the external entity computing system 190 as part of the ballot information. Further, the ballot information can also include a ballot box identifier that informs the external entity computing system 190 which ballot box 110 of a plurality of ballot boxes 110 received the ballot envelope.

The external entity computing system 190 can use the voter information to send a message to the voter informing them that their ballot has been received. The voter information can include voter contact information such as a phone number or email address that the external entity computing system 190 uses to send a text message, audio message, and/or email message to a voter contact device (e.g., a cell phone that can receive text messages, voice messages or emails, and/or a computing device with access to the voter's email address) with a confirmation statement that includes the timestamp and a ballot box identifier. Although the ballot information received at the external entity computing system 190 might include a serial number or other type of machine readable or human readable ballot box identifier, this information might not be useful to the voter. As such, the external entity computing system 190 can instead correlate the ballot box identifier with a more helpful descriptor that is sent out to the voter, such as a location that the ballot box was positioned at, such as a grocery store, library or municipal building. In one example, a message sent to a voter might say: “Dear [name]: Your ballot was received at [timestamp] at box #2 located at [store name] at [nearest crossroads].” The message can further include one or more contact points that the voter is invited to reach out to if they suspect an error or fraud (for instance, if the voter has not returned their ballot but receives a message stating that their ballot was received).

For this purpose, the computing system 160 can transmit at least the ballot identifier and timestamp to the external entity computing system 190 as soon as possible after receiving the ballot envelope such that the external entity computing system 190 can send the message to the voter shortly after receipt of the ballot envelope at the ballot box.

In some embodiments, the computing system 160 can flag suspicious ballot envelopes, such as in the event of a plurality of ballot envelopes being returned too closely in time to one another. Such criteria can include a minimum time interval between timestamps for a predetermined quantity of consecutive ballot envelopes such that the computing system 160 flags timestamps and scanned ballot envelopes that exhibit features of election interference such as ballot-harvesting. Following flagging of one or more ballot envelopes each received at a timestamp, poll workers and/or officials can examine the images captured by the one or more cameras 140 at or near the corresponding timestamps to determine whether a fraudulent event has occurred. In some embodiments, the computing system 160 can command the diverter mechanism 150 to divert one or more ballot envelopes that are received during a flagged drop-off event.

In some embodiments, by requiring a voter to scan their voter identification card or another government-issued identification card prior to dropping off their ballot envelope, it is expected that only one ballot envelope should be received per ID card scanned. As such, the computing system 160 can flag instances where two or more ballot envelopes are received per ID card scanned. Note that in some cases, some voters are unable to return their own ballots and some jurisdictions allow an authorized person to return a ballot on their behalf; in such a case, these returned ballot envelopes can be flagged by the envelope receipt system 100 for further review and approval by poll workers. In some embodiments, to accommodate such a situation, the computing system 160 can ask the voter if they are returning a ballot for another person and can include one or more input devices that enable the voter to enter their information as well as information about the person whose ballot they are returning. This information can be forwarded to the external entity computing system 190 along with the timestamp and ballot information.

In some embodiments, the lock can engage or disengage based on input from the computing system 160 or based on remote input from the external entity computing system 190, which can include a predetermined opening time and a predetermined closing time.

### Methods

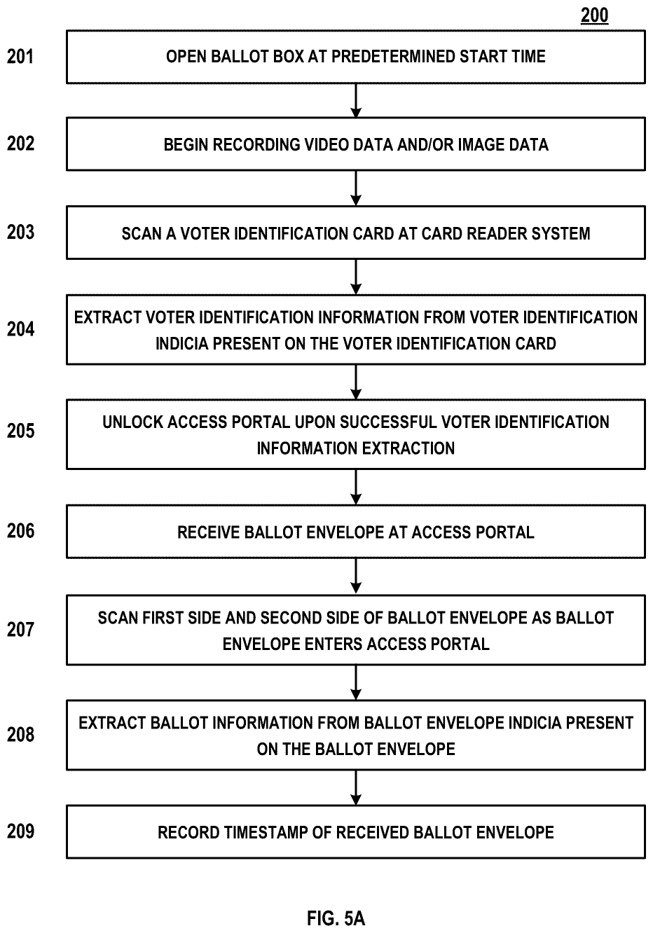

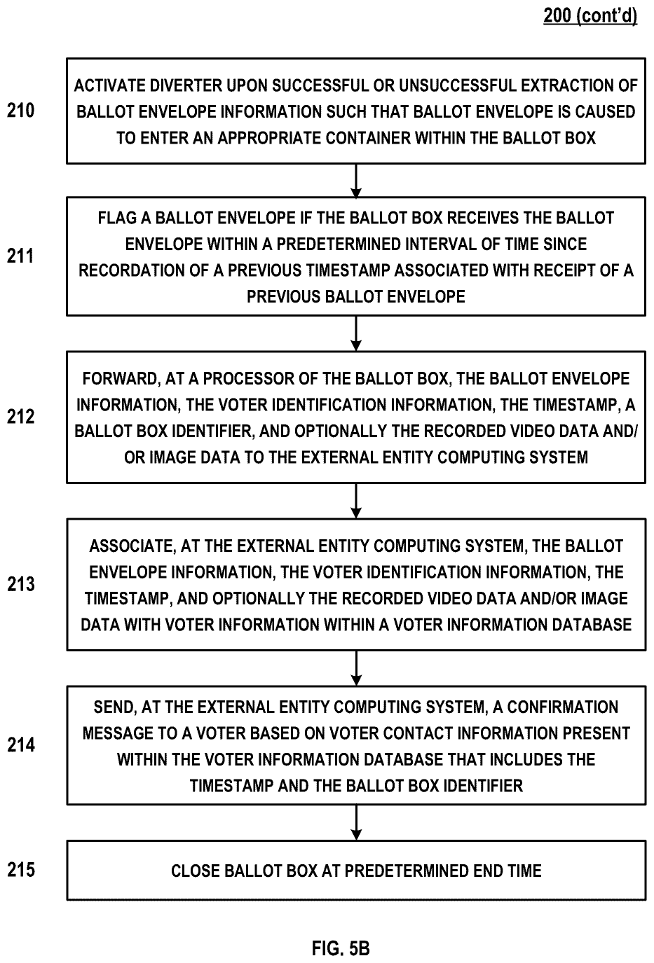

FIGS. 5A and 5B outline a method 200 for ballot receipt by the ballot envelope receipt system 100 of FIGS. 1-4. At block 201, the ballot box “opens” to enable acceptance of ballots at a predetermined start time (e.g., the beginning of the voting day). Note that in this context, “open” can be the state of being available to accept ballot envelopes, and does not necessarily mean that the entrance portal is opened to receive a ballot envelope (as the ballot box may still prevent access to the entrance portal until a voter has scanned an identification card). At block 202, the ballot box begins recording video data and/or image data, which can be continuous or can be triggered by motion outside the ballot box. In some embodiments, recordation of video data and/or image data can also take place before the start of the polling day.

At block 203, the ballot box scans a voter identification card of a voter at the card reader system. At block 204, the ballot box extracts voter identification information from voter identification indicia present on the voter identification card. At block 205, upon successful extraction of voter identification information, the ballot box can unlock the access portal to accept a ballot envelope. However, in some embodiments, even with failed extraction of voter identification information, the ballot box can unlock the access portal to accept a ballot envelope, but can activate a diverter mechanism to divert the ballot envelope into an “unscanned” sub-container.

At block 206, the ballot box can receive the ballot envelope at the access portal. At block 207, the ballot box can scan a first side and a second side of the ballot envelope at a scanner system as the ballot envelope enters the access portal. At block 208, the ballot box can extract ballot information from ballot envelope indicia present on the ballot envelope, and at block 209 the ballot box can record a timestamp of the received ballot envelope.

At block 210, the ballot box can activate the diverter upon successful or unsuccessful extraction of ballot envelope information such that the ballot envelope is caused to enter an appropriate container within the ballot box. In some embodiments, the diverter can be configured to activate upon successful extraction and can divert the ballot envelope into a “scanned” sub-container, which can be useful in the case of a system failure so that unscanned ballot envelopes always fall into the “unscanned” sub-container by default. In other embodiments, the diverter can be configured to activate upon unsuccessful extraction and can divert the ballot envelope into the “unscanned” sub-container, where scanned ballot envelopes fall into the “scanned” sub-container by default when the diverter is not activated. As discussed above, the ballot box can also cause the diverter to divert the received ballot envelope into the “unscanned” sub-container upon failure to extract voter identification information from the voter identification card. Further, at block 211, the ballot box can flag a ballot envelope if the ballot box receives the ballot envelope within a predetermined interval of time since recordation of a previous timestamp associated with receipt of a previous ballot envelope (e.g., the timestamps are too close together).

At block 212, the ballot box can forward the ballot envelope information, the voter identification information, the timestamp, a ballot box identifier, and optionally the recorded video data and/or image data to the external entity computing system. At block 213, the external entity computing system can associate the ballot envelope information, the voter identification information, the timestamp, and optionally the recorded video data and/or image data with voter information within a voter information database. At block 214, the external entity computing system can send a confirmation message to a voter based on voter contact information present within the voter information database that includes the timestamp and the ballot box identifier.

At block 215, the ballot box can “close” at a predetermined end time (e.g., at the end of the voting day) to prevent further interaction between the ballot box and voters. Following closure of the ballot box at the end of the voting day, the ballot box can continue to record video and/or image data to prevent tampering. Further, in some embodiments, the card reader system of the ballot box can remain functional to enable a poll worker to access the ballot box by scanning a card that indicates that the poll worker is authorized to access the ballot box.

### Computer-Implemented System

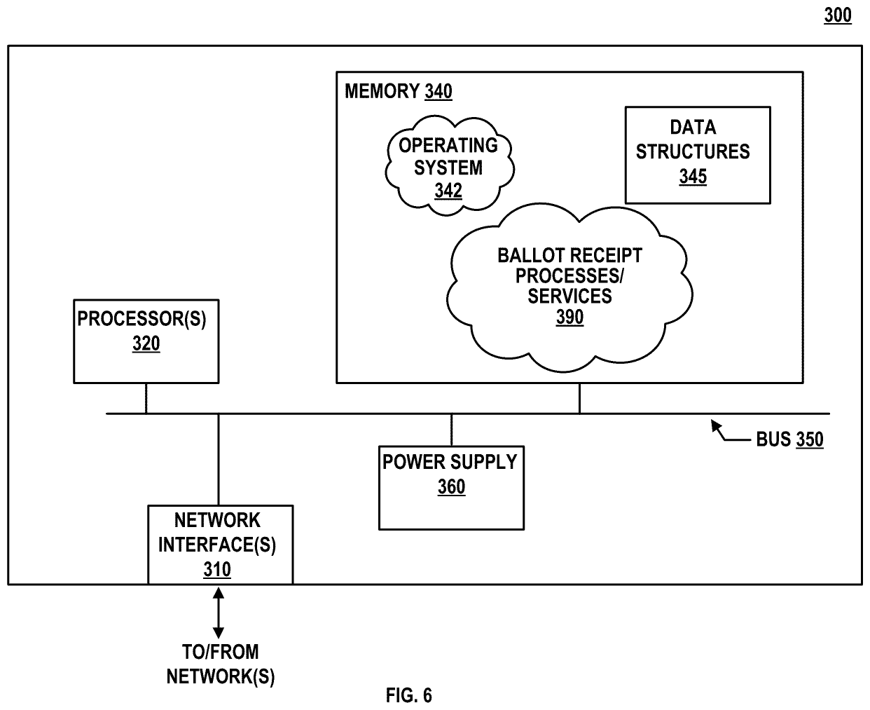

FIG. 6 is a schematic block diagram of an example device 300 that may be used with one or more embodiments described herein, e.g., as a component of ballot envelope receipt system 100 and/or as computing system 160 or external entity computing system 190 shown in FIGS. 1-4 and implementing aspects of method 200 shown in FIGS. 5A and 5B.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches).

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include ballot receipt processes/services 390 described herein. Note that while ballot receipt processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the ballot receipt processes/services 390 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a ballot box including:
an entrance portal in communication with a container configured to receive a ballot envelope;
a scanner system configured to extract ballot information from the ballot envelope upon receipt of the ballot envelope at the entrance portal, the ballot information including a timestamp; and
a computing system in communication with the scanner system that accesses voter information and records the timestamp and the ballot information,
wherein the ballot box accommodates secure receipt of the ballot envelope and verification of the voter information for improved ballot receipt and tracking during a voting process.

2. The system of claim 1, wherein the scanner system includes a first scanner configured to scan a first side of the ballot envelope and a second scanner configured to scan a second side of the ballot envelope.

3. The system of claim 1, wherein the computing system is configured to flag a ballot envelope when the ballot box receives the ballot envelope within a predetermined interval of time since recordation of a previous timestamp associated with receipt of a previous ballot envelope.

4. The system of claim 1, further comprising an external entity computing system in communication with the computing system of the ballot box, wherein the computing system of the ballot box is operable to communicate the ballot information and the timestamp to the external entity computing system.

5. The system of claim 4, wherein the external entity computing system is operable to retrieve voter information from a voting information database based on the ballot information and/or based on voter identification information.

6. The system of claim 4, wherein the external entity computing system is operable to send a confirmation message to a voter that includes the timestamp and an identifier associated with the ballot box.

7. The system of claim 1, wherein the ballot box further includes a diverter mechanism that diverts a ballot envelope to a sub-container when the scanner system fails to extract the ballot information from the ballot envelope.

8. The system of claim 1, further comprising one or more cameras, wherein the one or more cameras are operable for capturing an image of a person interacting with the ballot box.

9. The system of claim 1, further comprising a card reader system, wherein the card reader system is operable for capturing voter identification information from a voter identification card.

10. The system of claim 9, wherein the card reader system includes a barcode reader operable for capturing voter identification information from a barcode present on the voter identification card associated with the voter.

11. The system of claim 9, wherein the card reader system includes a magnetic stripe reader operable for capturing voter identification information from a magnetic stripe present on the voter identification card associated with the voter.

12. The system of claim 1, wherein the computing system includes one or more nonvolatile memory units operable for storing the timestamp, the ballot information, and/or voter identification information.

13. The system of claim 12, wherein the computing system includes two or more nonvolatile memory units in differing positions along the ballot box.

14. A method for secure ballot drop-off, comprising:
accessing voter information corresponding to a voter at a ballot box;
receiving a ballot envelope from the voter within a container defined by the ballot box;
recording a timestamp of receipt of the ballot envelope within the container;
extracting ballot information from at least one side of the ballot envelope upon receipt of the ballot envelope within the container; and
conducting one or more fraud prevention measures using the voter information and the timestamp to verify that receipt of the ballot is compliant with preexisting rules.

15. The method of claim 14, further comprising:
accessing the voter information from a voter identification card of a voter; and
verifying the voter information via a voter information database.

16. The method of claim 14, further comprising:
conducting a verification of the voter information; and
unlocking, in response to the verification, an access portal positioned along the container to accommodate receipt of the ballot envelope to within the container.

17. The method of claim 14, further comprising:
capturing one or more images of the voter engaging with the ballot box to verify the voter information.

18. The method of claim 14, wherein the one or more fraud prevention measures includes flagging receipt of the ballot envelope by determining that a difference in time between the timestamp and another timestamp corresponding to receipt of another ballot envelope is within a minimum time interval.

19. The method of claim 14, further comprising:
generating a notification that the receipt of the ballot envelope by the ballot box satisfies the one or more fraud prevention measures, the notification including an identifier associated with and identifying the ballot box.

20. The method of claim 14, wherein the one or more fraud prevention measures verifies chain of custody of the ballot envelope from a voter to the ballot box.
